(19) United States
(12) Patent Application Publication
(10) Pub. No.: US 2026/0350068 A1
(43) Pub. Date: Nov. 5, 2026

(54) RETRIEVAL AUGMENTED GENERATION USING QUERY ABSTRACTION FOR GENERATIVE MACHINE LEARNING MODELS

(71) Applicant: INTUIT INC., Mountain View, CA (US)

(72) Inventors: Shon MENDELSON, Tel Aviv (IL); Hadas BAUMER, Tel-Aviv (IL); Nitzan Gado SAGINHOR, Ness ziona (IL); Tom KLEIN, Tel Aviv (IL)

(21) Appl. No.: 19/194,592

(22) Filed: Apr. 30, 2025

(51) Int. Cl. G06F 16/334; G06F 16/338

(52) U.S. Cl. CPC G06F 16/334; G06F 16/338

(57) ABSTRACT

Aspects of the present disclosure relate to techniques for automated content generation using generative machine learning models. Embodiments include generating, using one or more extraction machine learning models based on an input query, one or more outputs indicating topics associated with the input query and entities associated with the input query. Embodiments further include retrieving a set of candidate texts from a corpus of texts based on, for each respective candidate text, a given distance in an embedding space between an embedding representation of the respective candidate text and embedding representations of the topics and a particular distance in the embedding space between an embedding representation of the respective candidate text and embedding representations of the entities. Embodiments further include generating a given output via a generative machine learning model based on the input query and one or more of the candidate texts.

### INTRODUCTION

Aspects of the present disclosure relate to techniques for automated content generation using generative machine learning models. In particular, techniques described herein involve a process for retrieving relevant texts based on an input query and then providing an input based on the retrieved texts and the input query to a generative machine learning model. Based on the retrieved texts, the generative machine learning model may be able to generate a robust and accurate response to the input query.

### BACKGROUND

A growing number of people, businesses, and organizations around the world use generative machine learning systems for performing various tasks. As an example, an individual may submit a query to a generative model, and the model may generate a response to the query that includes text, images, and/or the like. For instance, the query may be a question, and the response may be an answer to the question. As another example, the query may include a request to generate an image of an object, and the response may include an image that depicts the object.

Generative machine learning models may be capable of generating a large variety of content. To improve the quality of the generated content, contextual information that is relevant to a query may be retrieved based on the query and provided to the generative model based on the query in a process known as retrieval augmented generation (RAG). In an example RAG process, a query may relate to a particular subject. Based on the query, information that relates to the particular subject may be retrieved and provided to the generative model along with the query. The generative model may then use the retrieved information to generate a robust and accurate response to the query (e.g., an accurate answer to a question, an accurate text or image-based depiction of an object, and/or the like).

However, there are several technical challenges associated with existing RAG technologies. For instance, existing RAG systems may involve creating an embedding representation of a query and comparing the embedding representation to embedding representations of candidate documents to identify documents to include in the context. However, such techniques may fail to identify the most relevant context with an adequate level of precision and accuracy. As a result, these existing RAG techniques may result in low-quality outputs due to a lack of identified relevant context (or due to irrelevant context being identified and provided to the generative model).

Other, more accurate RAG techniques exist. However, these techniques often require an exorbitant amount of time and computational resources to perform. For example, a large language model (LLM) or other computationally costly model may be used to evaluate every text in a corpus and identify the relevant context for a given query. Due to the size of more accurate, robust models such as LLMs, using such models to retrieve context may add significant latency and cost to a RAG process. As a result, using a model such as an LLM to retrieve the context may be impractical for RAG applications.

Thus, there is a need in the art for improved techniques of automated content generation using generative machine learning models.

### BRIEF SUMMARY

Certain embodiments provide a method of automated content generation. The method generally includes: generating, using one or more extraction machine learning models based on an input query, one or more outputs indicating: one or more topics associated with the input query; and one or more entities associated with the input query; retrieving a set of candidate texts from a corpus of texts based on, for each respective candidate text: a given distance in an embedding space between an embedding representation of the respective candidate text and embedding representations of the one or more topics; and a particular distance in the embedding space between an embedding representation of the respective candidate text and embedding representations of the one or more entities; and generating a given output via a generative machine learning model based on the input query and one or more of the candidate texts.

Other embodiments provide processing systems configured to perform the aforementioned method as well as those described herein; non-transitory, computer-readable media comprising instructions that, when executed by one or more processors of a processing system, cause the processing system to perform the aforementioned method as well as those described herein; a computer program product embodied on a computer readable storage medium comprising code for performing the aforementioned method as well as those further described herein; and a processing system comprising means for performing the aforementioned method as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated content generation.

FIG. 2 depicts an additional example of computing components related to automated content generation.

FIG. 3 depicts an additional example of computing components related to automated content generation.

FIG. 4 depicts example operations related to automated content generation.

FIG. 5 depicts an example of a processing system for automated content generation.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automated content generation.

In some embodiments, an input query (e.g., a request for content such as an image or text, a question, and/or the like) may be provided to one or more extraction machine learning models. One of the extraction machine learning models may be a topic machine learning model that is trained to extract topics from queries. Another extraction machine learning model may be trained to extract entities (e.g., any items that may be related to a topic, such as a descriptor of a topic, a noun other than a topic within the query, words and phrases within the query, and/or the like) from queries. The set of weighted/unweighted topics and entities extracted from the input query (otherwise referred to as an abstraction of the query) may then be compared to a set of corpus texts (e.g., using a semantic similarity algorithm based on embeddings) to identify one or more corpus texts as candidates for inclusion in the context. The candidate texts may be provided to a ranking model (e.g., a large language model configured to rank texts based on relevance of the texts to an input query), and the ranking model may be used to select one or more candidates for inclusion in the context. When provided with the context and the input query, a generative model may be able to generate an accurate and robust response to the input query.

Embodiments of the present disclosure provide numerous technical and practical effects and benefits. For example, by retrieving context based on embeddings of topics and entities extracted from input queries using specialized extraction models, teachings disclosed herein allow for more precision and accuracy in identifying context than existing embedding-based RAG techniques (e.g., existing techniques that retrieve context based only on an embedding of the input query without the specialized techniques described herein for automatically extracting topics and entities from the input query for use in context retrieval). Accordingly, the outputs generated by embodiments disclosed herein will be more accurate and robust, since relevant context will not be omitted and/or irrelevant/excessive context will not be included. Furthermore, the context retrieval may be far quicker and far more efficient than techniques that rely on computationally expensive models (e.g., LLMs) to retrieve the context. As a result, techniques disclosed herein result in significant performance improvements for RAG systems. For example, the outputs generated according to embodiments of the present disclosure may be more accurate/robust than outputs generated using existing RAG techniques, and generating the outputs may require far less time and resources to perform. Additionally, these faster, higher-quality responses drastically improve the user experience, as users will no longer experience excessive latency or be presented with low-quality outputs produced based on irrelevant/incomplete context.

### Example of Computing Components Related to Automated Content Generation

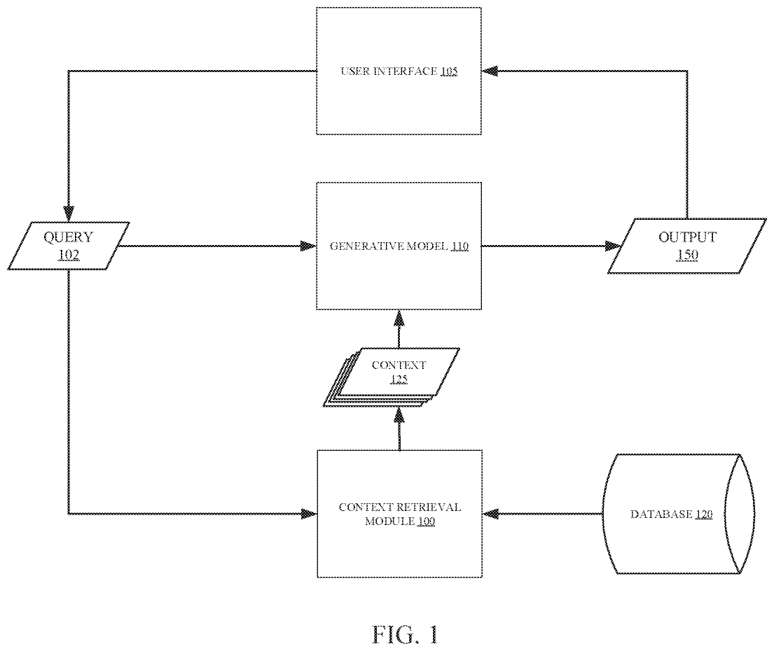

FIG. 1 depicts an example of computing components related to automated content generation.

A user may interact with a computing environment via a user interface 105 (e.g., a user interface of a computing device or a software application). The user may submit a query 102 via the user interface 105. Alternate embodiments provide that the query 102 may be submitted by a computing construct such as a software application. For example, a software application may automatically generate a query 102 such as based on user interactions with the software application (e.g., by populating a template using values that are determined based on the user interactions).

The query 102 may comprise text such as natural language text. For example, the query 102 may comprise a natural language request to perform a task (e.g., generate a particular type of content), a question, and/or the like.

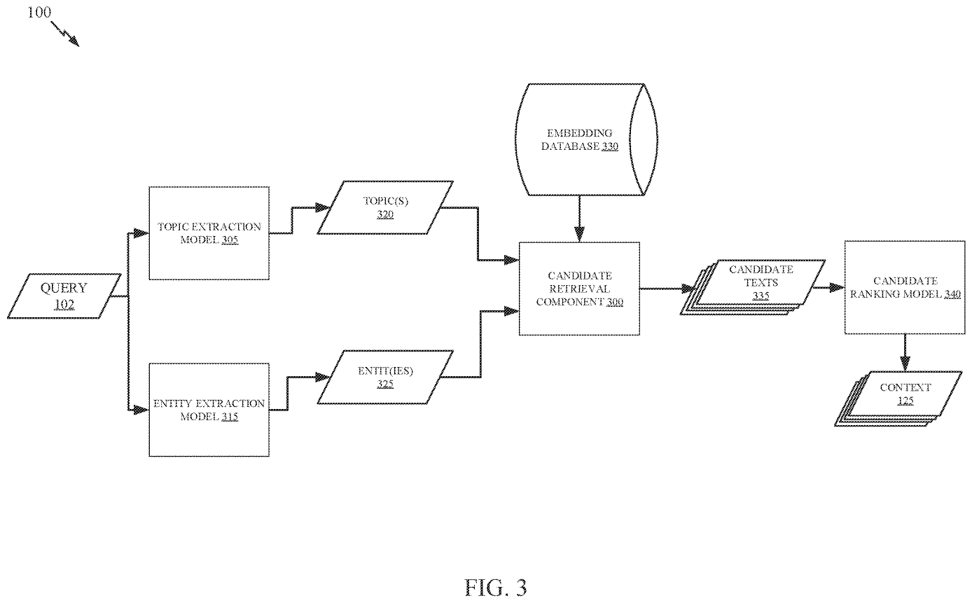

The query 102 may be provided to a context retrieval module 100. The context retrieval module 100 may be configured to extract context 125 that is relevant to the query 102 from a database 120, as described in further detail below with respect to FIG. 3. The context 125 may comprise texts that are relevant to the query 102. For example, a text in the context 125 may comprise a list of frequently asked questions and corresponding answers, and one of the questions may be similar to a question found in the query 102.

The query 102 and the context 125 may be provided as part of an input to a generative model 110. The generative model 110 may be any type of generative machine learning model such as a neural-network based model, a large language model (LLM), and/or the like. Based on the input, the generative model 110 may generate an output 150. The output 150 may comprise a response to the query 102 (e.g., the content requested in the query 102, an answer to a question in the query 102, and/or the like). The output 150 may be provided to the user via the user interface 105.

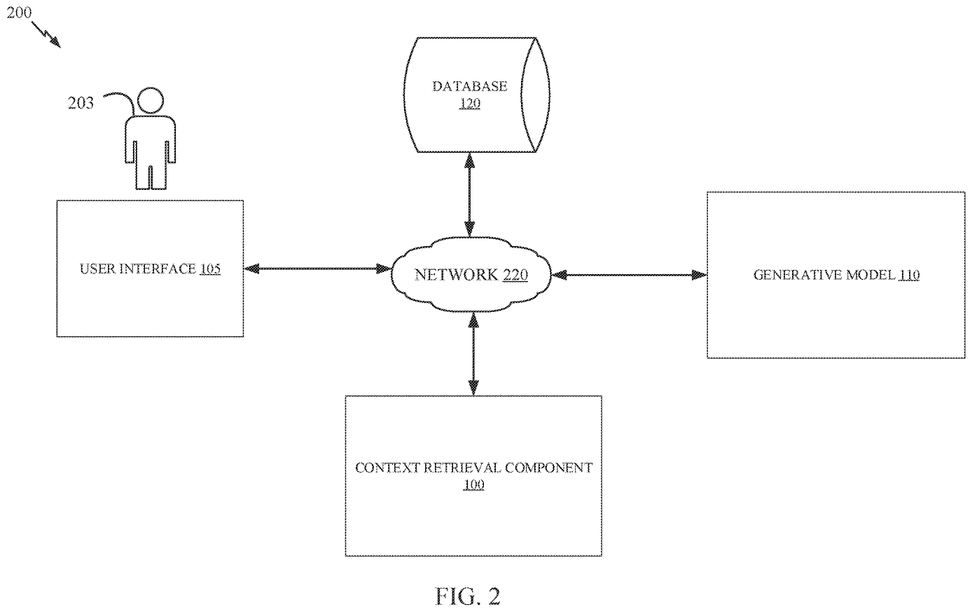

FIG. 2 depicts an additional example of computing components related to automated content generation.

A user 203 may interact with a computing environment 200 via a user interface 205 associated with a computing device. The computing environment 200 may, for example, comprise a software application. The software application may use context retrieval component 100 and generative model 110 to generate content based on queries provided by the user 203. For example, as described above with respect to FIG. 1, context retrieval component 100 may retrieve a set of context texts that are then provided to generative model 110, which may then generate an output based on the context texts. The generated output may then be provided to the user 203 via the user interface 105.

In some embodiments, the computing environment 200 further comprises a database 120 that stores texts and/or embeddings thereof. The context retrieval component 100 may search the database 120 to identify relevant context texts. According to some embodiments, previously provided queries may be stored in the database 120 along with the contexts retrieved for the previously provided queries. If a newly received query is determined to be similar to a previously provided query (e.g., the similarity exceeds a threshold based on a comparison of embedding representations of the newly received query and the previous query, based on a text comparison of the newly received query and the previous query, and/or the like), the context retrieved for the previous query may be used as the context for the newly received query.

An embedding generally refers to a vector representation of a text item that represents the item as a vector in n-dimensional space such that similar items are represented by vectors that are close to one another in the n-dimensional space. A machine learning model used to create embeddings may comprise a neural network or other type of machine learning model that learns a representation (embedding) for an item through a training process that trains the neural network based on a data set, such as a plurality of features of a plurality of items. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and Glo Ve embeddings. These are included as examples, and other techniques for generating vector representations of entities (such as embedding representations) are possible.

The software application associated with the user interface 105, the context retrieval component 100, generative model 110, and the database 120 may interact over network 220. Network 220 may be any connection over which data may be transmitted. In one example, network 220 is the Internet.

FIG. 3 depicts an additional example of computing components related to automated content generation. In particular, FIG. 3 depicts functionality associated with context retrieval component 100 of FIG. 1 and FIG. 2.

The query 102 may be provided to one or more extraction machine learning models such as a topic extraction model 305 and an entity extraction model 315. The topic extraction model 305 may comprise a machine learning model (e.g., a neural network-based model) that is configured to extract one or more topics 320 from the query 102. For example, the topic extraction model 305 may comprise a Bidirectional Encoder Representation from Transformer topic (BERTopic) model or a Feature-wise Linear Modulation (FiLM) model. The topic extraction model 305 may be trained (e.g., through a supervised, unsupervised, or semi-supervised learning process) to identify topics within queries. The topic extraction model 305 may extract topics by generating embeddings of words and/or phrases within the query 102 and comparing the embeddings to known embeddings of topics. In some embodiments, the topic extraction model 305 may also generate a weight for each extracted topic, such as representing an extent to which each extracted topic is relevant to the query 102 (e.g., based on embedding distance). For example, three topics may be extracted. As part of the extraction, the topic extraction model 305 may determine that a first topic is highly important to the query 102. Accordingly, this topic may be given a relatively high weight compared to the other topics. The other topics may have been determined to be less important to the query 102, and may thus be given weights that are lower than the weight of the first topic. In some embodiments, each topic may be given the same weight.

The entity extraction model 315 may comprise a machine learning model (e.g., a neural network-based model) that is configured to extract one or more entities 325 from the query. For example, the entity extraction model 315 may comprise a named entity recognition (NER) model such as a BERT-based NER model or FiLM NER model. The entity extraction model 315 may be trained (e.g., through a supervised, unsupervised, or semi-supervised learning process) to identify entities within queries. The entity extraction model 315 may extract entities by generating embeddings of words and/or phrases within the query 102 and comparing the embeddings to known embeddings of entities. In some embodiments, the entity extraction model 315 may also generate a weight for each extracted entity, such as representing an extent to which each extracted entity is relevant to the query 102 (e.g., based on embedding distance). For example, three entities may be extracted. As part of the extraction, the entity extraction model 315 may determine that a first entity is highly important to the query 102. Accordingly, this entity may be given a relatively high weight compared to the other entities. The other entities may have been determined to be less important to the query 102, and may thus be given weights that are lower than the weight of the first entity. In some embodiments, each entity may be given the same weight. This weight may be lower than a common weight that is assigned to each topic. In some embodiments, the topic extraction model 305 and the entity extraction model 315 may be implemented as part of the same machine learning model, the topic extraction model, 305 and the entity extraction model 315 may be implemented together as an ensemble model, or the topic extraction model 305 and the entity extraction model 315 may be implemented as separate models.

Supervised learning techniques generally involve providing training inputs to a machine learning model. The machine learning model processes the training inputs and outputs predictions based on the training inputs. The predictions are compared to known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Model parameters adjusted during training may include, for example, hyperparameters, values related to numbers of iterations, weights, functions used by nodes to calculate scores, level of randomness, and/or the like. In some embodiments, validation and testing are also performed for a machine learning model (e.g., topic extraction model 305, entity extraction model 315, and/or any other model used in techniques described herein), such as based on validation data and test data, as is known in the art.

For example, the extraction models may be trained through a supervised learning process involving training data that comprises queries that are associated with ground truth labels indicating topics, entities, and/or weights for the topics/entities. Parameters of the extraction models may be iteratively adjusted until the outputs generated by the extraction models based on the queries matches the topics/entities/weights indicated by the labels or another condition is met. In some embodiments, backpropagation is used to adjust the parameters of the models by propagating a gradient through the nodes of the models based on a variance between the outputs and the ground truth.

In some embodiments, the extracted topics and entities may be weighted relative to each other. For example, if a topic is more important than an entity, the topic may be assigned a weight that is higher than the weight assigned to the entity.

According to certain embodiments, only entities and topics that have a level of relevance with respect to the query 102 that is above a threshold may be extracted. In some embodiments, only the most relevant entities and topics may be extracted. For example, the three most relevant entities/topics may be extracted and other entities/topics may be omitted.

In an example, a query may comprise the following text: “How do I connect my wireless headphones to my desktop computer?” Extracted topics for this query may include troubleshooting and wireless pairing. A topic generally refers to a subject or category to which a query may relate, and many queries and/or entities may related to a single topic just as a single query and/or entity may relate to multiple topics. Extracted entities for this query may include “headphones” and “desktop.” As depicted in this example, the entities are text strings that provide additional details about the topics. For example, an entity may be a keyword, key phrase, and/or the like. A topic is wireless pairing, and the entities “desktop” and “headphones” indicate that the wireless pairing will involve pairing the headphones to the desktop computer.

The extracted topics 320 and entities 325 (and/or embedding representations thereof) may be provided to a candidate retrieval component 300, which may be configured to retrieve candidate texts 335 (i.e., texts that are candidates to be included in the context 125). The candidate retrieval component 300 may be configured to use a semantic similarity algorithm (e.g., cosine similarity, edit distance, and/or the like) to identify candidate texts 335. The distance in an embedding space between an embedding representation of a topic 320 and an embedding representation of a text stored in an embedding database 330 may be determined. The distance in an embedding space between an embedding representation of an entity 325 and the embedding representation of the text may also be determined. Generally, larger distances in an embedding space between two items indicates that the items are less similar than items that are closer together. Based on the distances, a similarity score for the document may be determined. For example, the similarity score may be an average or a weighted average of the distances that were determined for the topic 320 and the entity 325. The weights used in the weighted average may be the weights assigned by the topic extraction model 305 and entity extraction model 315. The texts that are most similar to the extracted entities 325 and topics 320 may be selected as candidate texts 335. For example, texts with similarity scores above a threshold (or below the threshold, if lower scores are used to indicate higher similarity and higher scores are used to indicate lower similarity) may be included in the set of candidate texts 335. Or, the texts with the highest similarity scores (e.g., the top 100 scoring texts) may be included in the candidate texts 335.

The candidate texts 335 may be retrieved from a corpus of texts (e.g., the texts with embedding representations stored in embedding database 330). In certain embodiments, the corpus of texts is retrieved based on the query 102 using one or more search techniques. For example, a text-based search may be performed over a much larger set of texts to identify the corpus, or an embedding-based search may be performed over the larger set of texts to identify the corpus. Then, the extraction models may be used to narrow the corpus into the candidate texts 335, as described herein.

In an example, a query 102 may have two extracted topics 320 (e.g., topics A and B) and four extracted entities 325 (e.g., entities A, B, C, and D). Topic A may be more important to the query 102 than topic B. Thus, topic A may have a higher weight than topic B. The entities may have lower weights than either of the topics (and/or the entities as a group may have a lower weight than the topics, as a group and/or individually). Text A may be much closer in the embedding space to topics A and B than text B. As a result, text A may have a much higher similarity score with respect to the query 102 than text B, even if text B is somewhat closer to the entities in the embedding space than text A. Thus, text A may be included in the candidate texts 335 while text B may be omitted. Text C may be relatively close in the embedding space to topic A and relatively further away from topic B. Since topic A is weighted higher than topic B, text C may be included in the candidate texts. By contrast, text D may be relatively close in the embedding space to topic B and relatively further away from topic A. Since topic A is weighted higher than topic B, text D may have a much lower similarity score than text C and thus may be omitted from the candidate texts.

The candidate texts 335 may be provided as part of an input to a generative machine learning model along with the query 102, as described above with respect to FIG. 1. In other words, the full set of candidate texts 335 may be used as the context 125.

In some embodiments, the candidate texts 335 (and, in certain embodiments, the query 102 as well) may be provided to a candidate ranking model 340. The candidate ranking model 340 may comprise a machine learning model such as an LLM that is trained and/or otherwise configured to rank/score candidate texts 335 based on relevance to the query 102. The candidate texts 335 with the highest scores and/or scores above a threshold may be included in the context 125. By narrowing a corpus of texts into a set of candidate texts 335 using the extraction models and then using the more computationally costly candidate ranking model 340 to rank the candidate texts 335, embodiments disclosed herein use significantly fewer computational resources than using the candidate ranking model 340 to rank the entire corpus while achieving similar or improved quality of generated content.

Certain embodiments provide that the texts in the context 125 are queries and/or questions extracted from documents (e.g., using an LLM or an extraction model). Excerpts from the documents may be included along with the texts in the context 125 when such texts are included in the context 125.

According to some embodiments, user feedback may be received with respect to outputs generated based on the context 125 and/or based on the context 125 itself. For example, a user may indicate dissatisfaction with the output (e.g., by providing an input to a user interface). Based on the indication, one or more context retrieval steps may be repeated. For example, a new corpus may be selected, new candidate texts may be identified, and new rankings may be used to select a new context 125. For outputs that receive negative feedback, the extracted topics/entities may be flagged for review/replacement, and additional texts may be added to the corpus that correspond to these topics/entities. Also, the texts that were used to generate the output may be flagged for analysis and potential replacement. Certain embodiments provide that texts that are retrieved for many different topics (e.g., topics for which outputs received negative feedback) may be flagged for revision and clarification. In some embodiments, one or more machine learning models (e.g., topic extraction model 305, entity extraction model 315, and/or the generative model) may be retrained based on user feedback (e.g., the output and the context provided to generate the output may be used as a negative training example in training data).

In some embodiments, the candidate retrieval and context retrieval processes may be used as a fallback for other context retrieval techniques. For example, a simple text-based or embedding-based search may be used as a first option to retrieve context for a given query. If the simple text-based or embedding-based search is unable to identify texts to include in the context (or identifies too many texts and/or texts that are not relevant), the extraction models may be invoked to identify candidates and context as disclosed herein.

Certain embodiments provide that a rephrasing machine learning model (e.g., an LLM) may be trained and/or otherwise configured to rephrase the context 125 in terms of the query 102 and/or to rephrase the query 102 in terms of the context 125. When the query 102 has a stronger resemblance (e.g., stylistically and/or semantically) to the retrieved context 125, the generative machine learning model may be better able to generate a response to the query 102. When the context 125 more strongly resembles the query 102, the resulting output response may be more closely personalized to the user.

### Example Operations Related to Automated Content Generation

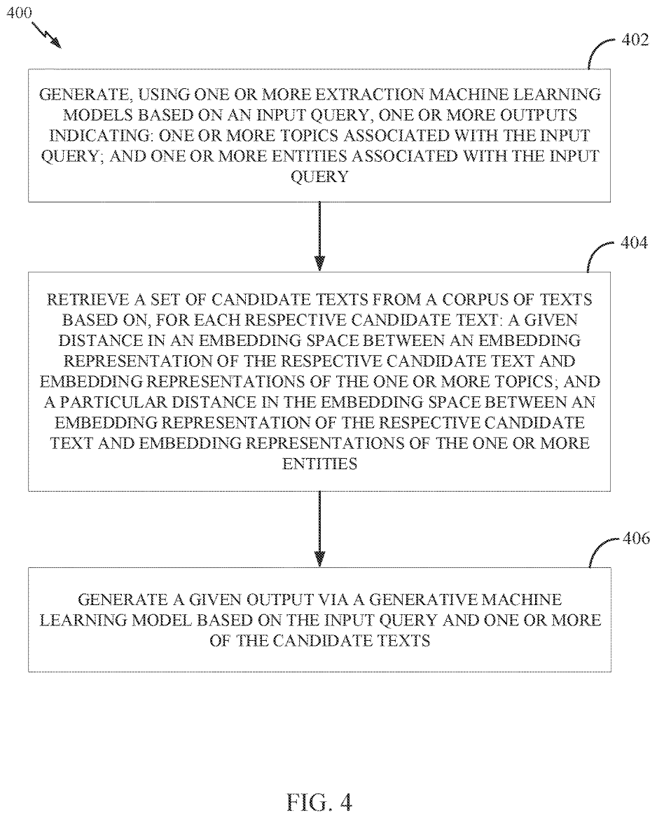

FIG. 4 depicts example operations 400 related to automated content generation. For example, operations 400 may be performed by one or more of the components described with respect to FIG. 1, FIG. 2, and FIG. 3.

Operations 400 begin at step 402 with generating, using one or more extraction machine learning models based on an input query, one or more outputs indicating: one or more topics associated with the input query; and one or more entities associated with the input query. In some embodiments, the one or more extraction machine learning models comprise a named entity recognition (NER) machine learning model that is used to extract the one or more entities. Certain embodiments provide that the one or more extraction machine learning models comprise an embedding model that is used to extract the one or more topics and generate the embedding representations of the one or more topics. According to some embodiments, the one or more extraction machine learning models are configured to generate outputs that indicate: a set of topics and entities that have a relevance above a threshold with respect to input queries; or a set of topics and entities that have a relevance with respect to input queries that is higher than a relevance of other topics and entities not included in the set of topics and entities.

Operations 400 continue at step 404 with retrieving a set of candidate texts from a corpus of texts based on, for each respective candidate text: a given distance in an embedding space between an embedding representation of the respective candidate text and embedding representations of the one or more topics; and a particular distance in the embedding space between an embedding representation of the respective candidate text and embedding representations of the one or more entities. Some embodiments provide that the corpus of texts is retrieved based a semantic similarity comparison between an embedding representation of the input query and embedding representations of each text of a set of texts that includes more texts than the corpus of texts. Certain embodiments provide that retrieving the set of candidate texts from the corpus of texts is further based on weights included in the one or more outputs for each topic of the one or more topics and each entity of the one or more entities.

Operations 400 continue at step 406 with generating a given output via a generative machine learning model based on the input query and one or more of the candidate texts.

According to some embodiments, operations 400 further include providing the input query and the set of candidate texts to a ranking machine learning model; and receiving a ranking output from the ranking machine learning model based on the input query and the set of candidate texts, wherein the ranking output indicates a subset of candidate texts that are most relevant to the input query, wherein the set of candidate texts are provided as part of an input to the generative machine learning model based on the ranking output.

In certain embodiments, operations 400 further include providing the input query and the candidate texts as input to a rephrasing machine learning model, wherein the rephrasing machine learning model generates modified versions of the candidate texts that are modified based on the input query, wherein the modified versions of the candidate texts are included in an input to the generative machine learning model.

Some embodiments provide that operations 400 further include providing the input query and the candidate texts as input to a rephrasing machine learning model, wherein the rephrasing machine learning model generates a modified version of the input query that is modified based on the candidate texts, wherein the modified version of the input query is included in an input to the generative machine learning model.

Certain embodiments provide that operations 400 further include storing the input query with the set of candidate texts; receiving an additional input query; providing the set of candidate texts and the additional input query as part of an input to the generative machine learning model based on a level of similarity between the additional input query and the input query being above a threshold.

### Example of a Processing System for Automated Content Generation

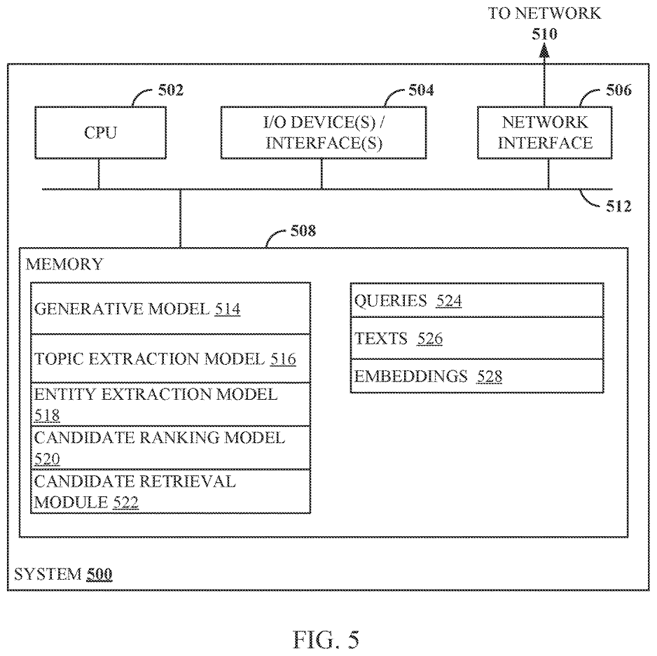

FIG. 5 illustrates an example system 500 with which embodiments of the present disclosure may be implemented. For example, system 500 may be configured to perform operations 400 of FIG. 4 and/or to implement one or more components as in FIG. 1, FIG. 2, and FIG. 3.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 808. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes generative model 514, topic extraction model 516, entity extraction model 518, candidate ranking model 520, and candidate retrieval module 522. In some embodiments, generative model 514 may be representative of generative model 110 of FIG. 1 or FIG. 2. Topic extraction model 516 may be representative of topic extraction model 305 of FIG. 3. Entity extraction model 518 may be entity extraction model 315 of FIG. 3. Candidate ranking model 520 may be candidate ranking model 340 of FIG. 3. Candidate retrieval module 522 may be candidate retrieval module 300 of FIG. 3.

Memory 508 further comprises queries 524, which may correspond to query 102 of FIG. 1, or FIG. 3. Memory 508 further comprises texts 526, which may correspond to texts included in a corpus texts, candidate texts, texts included in the context, and/or the like. Memory 508 further comprises embeddings 528, which may correspond to embedding representations of texts, topics, entities, and/or the like.

It is noted that in some embodiments, system 500 may interact with one or more external components, such as via network 510, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for automated content generation, comprising:
generating, using one or more extraction machine learning models based on an input query, one or more outputs comprising:
embedding representations of multiple topics associated with the input query, wherein a topic of the multiple topics comprises a subject to which the input query relates, wherein the subject is not explicitly stated in the input query, wherein the multiple embedding representations include a first embedding representation of a first topic and a second embedding representation of a second topic, wherein the first embedding representation has a first weight and the second embedding representation has a second weight, and wherein the first weight is higher than the second weight based on the first topic having a higher level of relevance with respect to the input query than the second topic; and
embedding representations of one or more entities associated with the input query;
retrieving a set of candidate texts from a corpus of texts based on, for each respective candidate text:
a given distance in an embedding space between an embedding representation of the respective candidate text and the embedding representations of the multiple topics;
a particular distance in the embedding space between an embedding representation of the respective candidate text and the embedding representations of the one or more entities; and
wherein retrieving the candidate texts is further based on the first weight and the second weight; and
generating a given output via a generative machine learning model based on the input query and one or more of the candidate texts.

2. The method of claim 1, wherein the one or more extraction machine learning models comprise a named entity recognition (NER) machine learning model that is used to extract the one or more entities.

3. The method of claim 1, wherein the one or more extraction machine learning models comprise an embedding model that is used to extract the multiple topics and generate the embedding representations of the multiple topics.

4. The method of claim 1, further comprising:
providing the input query and the set of candidate texts to a ranking machine learning model; and
receiving a ranking output from the ranking machine learning model based on the input query and the set of candidate texts, wherein the ranking output indicates a subset of candidate texts that are most relevant to the input query, wherein the set of candidate texts are provided as part of an input to the generative machine learning model based on the ranking output.

5. The method of claim 1, further comprising providing the input query and the candidate texts as input to a rephrasing machine learning model, wherein the rephrasing machine learning model generates modified versions of the candidate texts that are modified to more semantically and stylistically resemble the input query, wherein the modified versions of the candidate texts are included in an input to the generative machine learning model.

6. The method of claim 1, further comprising providing the input query and the candidate texts as input to a rephrasing machine learning model, wherein the rephrasing machine learning model generates a modified version of the input query that is modified to more semantically and stylistically resemble the candidate texts, wherein the modified version of the input query is included in an input to the generative machine learning model.

7. The method of claim 1, further comprising:
storing the input query with the set of candidate texts;
receiving an additional input query; and
providing the set of candidate texts and the additional input query as part of an input to the generative machine learning model based on a level of similarity between the additional input query and the input query being above a threshold.

8. The method of claim 1, wherein the corpus of texts is retrieved based a semantic similarity comparison between an embedding representation of the input query and embedding representations of each text of a set of texts that includes more texts than the corpus of texts.

9. The method of claim 1, wherein retrieving the set of candidate texts from the corpus of texts is further based on weights included in the one or more outputs for each topic of the multiple topics and each entity of the one or more entities.

10. The method of claim 1, wherein the one or more extraction machine learning models are configured to generate outputs that indicate:
a set of topics and entities that have a relevance above a threshold with respect to input queries; or
a set of topics and entities that have a relevance with respect to input queries that is higher than a relevance of other topics and entities not included in the set of topics and entities.

11. A system for automated content generation, comprising:
one or more processors; and
a memory comprising instructions that, when executed by the one or more processors, cause the system to:
generate, using one or more extraction machine learning models based on an input query, one or more outputs comprising:
embedding representations of multiple topics associated with the input query, wherein a topic of the multiple_topics comprises a subject to which the input query relates, wherein the subject is not explicitly stated in the input query, wherein the multiple embedding representations include a first embedding representation of a first topic and a second embedding representation of a second topic, wherein the first embedding representation has a first weight and the second embedding representation has a second weight, and wherein the first weight is higher than the second weight based on the first topic having a higher level of relevance with respect to the input query than the second topic; and
embedding representations of one or more entities associated with the input query;
retrieve a set of candidate texts from a corpus of texts based on, for each respective candidate text:
a given distance in an embedding space between an embedding representation of the respective candidate text and the embedding representations of the multiple topics;
a particular distance in the embedding space between an embedding representation of the respective candidate text and the embedding representations of the entities; and
wherein retrieving the candidate texts is further based on the first weight and the second weight; and
generate a given output via a generative machine learning model based on the input query and one or more of the candidate texts.

12. The system of claim 11, wherein the one or more extraction machine learning models comprise a named entity recognition (NER) machine learning model that is used to extract the one or more entities.

13. The system of claim 11, wherein the one or more extraction machine learning models comprise an embedding model that is used to extract the multiple topics and generate the embedding representations of the multiple topics.

14. The system of claim 11, wherein the instructions, when executed by the one or more processors, further cause the system to:
provide the input query and the set of candidate texts to a ranking machine learning model; and
receive a ranking output from the ranking machine learning model based on the input query and the set of candidate texts, wherein the ranking output indicates a subset of candidate texts that are most relevant to the input query, wherein the set of candidate texts are provided as part of an input to the generative machine learning model based on the ranking output.

15. The system of claim 11, wherein the instructions, when executed by the one or more processors, further cause the system to provide the input query and the candidate texts as input to a rephrasing machine learning model, wherein the rephrasing machine learning model generates modified versions of the candidate texts that are modified to more semantically and stylistically resemble the input query, wherein the modified versions of the candidate texts are included in an input to the generative machine learning model.

16. The system of claim 11, wherein the instructions, when executed by the one or more processors, further cause the system to provide the input query and the candidate texts as input to a rephrasing machine learning model, wherein the rephrasing machine learning model generates a modified version of the input query that is modified to more semantically and stylistically resemble the candidate texts, wherein the modified version of the input query is included in an input to the generative machine learning model.

17. The system of claim 11, wherein the instructions, when executed by the one or more processors, further cause the system to:
store the input query with the set of candidate texts;
receive an additional input query;
provide the set of candidate texts and the additional input query as part of an input to the generative machine learning model based on a level of similarity between the additional input query and the input query being above a threshold.

18. The system of claim 11, wherein the corpus of texts is retrieved based a semantic similarity comparison between an embedding representation of the input query and embedding representations of each text of a set of texts that includes more texts than the corpus of texts.

19. The system of claim 11, wherein retrieving the set of candidate texts from the corpus of texts is further based on weights included in the one or more outputs for each topic of the multiple topics and each entity of the one or more entities.

20. A non-transitory computer readable medium comprising instructions that, when executed by one or more processors of a computing system, cause the computing system to:
generate, using one or more extraction machine learning models based on an input query, one or more outputs comprising:
embedding representations of multiple topics associated with the input query, wherein a topic of the multiple_topics comprises a subject to which the input query relates, wherein the subject is not explicitly stated in the input query, wherein the multiple embedding representations include a first embedding representation of a first topic and a second embedding representation of a second topic, wherein the first embedding representation has a first weight and the second embedding representation has a second weight, and wherein the first weight is higher than the second weight based on the first topic having a higher level of relevance with respect to the input query than the second topic; and
embedding representations of one or more entities associated with the input query;
retrieve a set of candidate texts from a corpus of texts based on, for each respective candidate text:
a given distance in an embedding space between an embedding representation of the respective candidate text and the embedding representations of the multiple topics;
a particular distance in the embedding space between an embedding representation of the respective candidate text and the embedding representations of the one or more entities; and
wherein retrieving the candidate texts is further based on the first weight and the second weight; and
generate a given output via a generative machine learning model based on the input query and one or more of the candidate texts.
